(19) United States
(12) Patent Application Publication
(10) Pub. No.: US 2014/0142479 A1
(43) Pub. Date: May 22, 2014

(54) LUGGAGE AND BAG MASSAGER

(71) Applicants: Harjinder Kaur, Reading, MA (US); Manwinder Singh, Reading, MA (US)

(72) Inventors: Harjinder Kaur, Reading, MA (US); Manwinder Singh, Reading, MA (US)

(21) Appl. No.: 13/889,904

(22) Filed: May 8, 2013

Related U.S. Application Data
(60) Provisional application No. 61/727,167, filed on Nov. 16, 2012.

(51) Int. Cl. A61H 15/00

(52) U.S. Cl. CPC A61H 15/00
USPC 601/118

(57) ABSTRACT

A combination luggage bag and massager is disclosed comprising massaging devices mounted on the bag such that a user can rub a body part against the massaging device to cause a massaging action to the portion of the user's body in contact with the massaging devices.

### CROSS REFERENCE TO RELATED APPLICATIONS

This application is a non-provisional patent application of, and claims the benefit to U.S. provisional patent application No. 61/727,167 filed Nov. 26, 2012.

### BACKGROUND OF THE INVENTION

1. Field of the Invention

The present invention relates generally to luggage bags. More specifically, the present invention relates to carryon luggage that is kept in the general proximity of a passenger when traveling on a passenger airplane. The present invention also relates to foot rest and massagers which ease muscle tension and help to improve blood flow.

2. Description of Related Art

One of the most common forms of travel in the world today is flying on an airplane owned and operated by a commercial airline. Flying on an airplane has many advantages, the most prominent of which is the fact that it is the fastest commercially available travel method. A trip across the continent that would normally take days by car can take only hours by plane. It is because of this massive speed advantage that flying is such a common form of travel in the modern world. Despite this massive advantage, flying does come with several disadvantages that can be troublesome to a traveler. Such disadvantages include the fact that security is very tight, lines are often long, flights can be delayed or even cancelled, and the seating arrangements in the airplanes can often be very cramped and uncomfortable. The speed offered through travelling by plane often outweighs the disadvantages mentioned above. Additionally, there is almost nothing the traveler can do to avoid these disadvantages, security is annoying but highly necessary to ensure passenger safety, long lines are hard to avoid, especially on holidays, delayed and cancelled flights are the responsibility of the airlines, and cramped seating arrangements cannot be changed by the traveler. However, unlike the other disadvantages, there are some things a traveler can do to help increase their comfort during a flight. One of the major causes for discomfort in cramped environments is poor blood flow in the extremities. Poor blood flow to the extremities can be caused by lack of motion and pressure points on the body from sitting in a certain position. Flexing limbs and repositioning slightly can help to improve blood flow and decrease discomfort experience by the traveler. Although performing such small exercises can help to decrease the discomfort experience by the traveler, it is clear that there is significant opportunity for improvement in this area. Resultantly, it is the object of the present invention to create a canyon bag which is specifically designed to incorporate a plurality of massaging surfaces at different angles to allow flexing and resting in different positions. The plurality of massaging surfaces are intended to allow the traveler to use the canyon bag to increase blood flow through massaging action.

### SUMMARY OF THE INVENTION

The subject matter of this application may involve, in some cases, interrelated products, alternative solutions to a particular problem, and/or a plurality of different uses of a single system or article.

In one aspect, a combination luggage bag and massager is presented. In one embodiment, the combination luggage bag and massager may comprise a housing having a lower portion and an upper portion. The lower portion may have a base and a peripheral wall being attached to, and extending upwardly from, the base to form a first compartment. The upper portion may have an outwardly curved top surface attached to two opposing surfaces on each side to form a generally hollow interior. The hollow interior may have a peripheral edge defining an opening into a second compartment. In another embodiment, the upper portion may be pivotally coupled to the lower portion along a common edge and may be positionable in a closed position extending over the first compartment.

In yet another embodiment, a closure may be attached to the peripheral edge of the upper portion to secure the upper portion to the lower portion in the closed position.

In another embodiment, one massaging device may be mounted on the top surface of the upper portion such that a user can rub a body part against the massaging device when the combination luggage bag and massager is in a horizontal position, the horizontal position being when the base of the lower portion is resting on a generally flat surface.

In another aspect, a method for massaging a body part using a combination luggage bag and massager is provided. The method may begin by providing a combination luggage bag and massager with a massaging device mounted on a top surface of the upper portion of the bag. This may be followed by positioning the combination luggage bag and massager in a horizontal position with the base of the lower portion of the bag resting on a generally flat surface. A user may then rub a body part against the massaging device when the combination luggage bag and massager is in the horizontal position.

### BRIEF DESCRIPTION OF THE DRAWINGS

FIG. 1A is an elevation view showing the top and sides of a combination luggage bag and massager according to the present invention.

FIG. 1B is a transverse cross-sectional view taken along dotted line AA of FIG. 1A.

FIG. 2A is a perspective view of the present invention showing feet resting on a low angle surface of the invention.

FIG. 2B is a perspective view of the present invention showing feet resting on a high angle surface of the invention.

FIG. 3 is another perspective view of the present invention where handle of the bag is used to provide massaging action to the hamstring muscles and the combination luggage bag and massager is used in a vertical position to allow raised elevation for feet and legs.

FIG. 4 is a detail perspective view of the bag in open position showing checkpoint friendly first compartment for storing a portable computer.

### DETAILED DESCRIPTION OF THE INVENTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention relates to a combination luggage bag and massager and methods for massaging a body part using the combination luggage bag and massager.

The present invention is a combination luggage bag and massager. The present invention comprises a luggage bag, foot rest including a plurality of massaging surfaces and multiple rolling massagers. Luggage bags are well known in the prior art for carrying various items such as clothing. In the modern world, luggage bags can be broken down into two general categories, carryon bags and full size bags. Full size bags are large and bulky and are designed to carry the bulk of whatever a traveler needs to bring with them on a trip. Canyon bags are the opposite of this; they are small and compact and typically only fit personal items like a laptop computer and or enough clothing for a shorter trip. Additionally, canyon bags are often specifically designed such that they fit into the overhead storage compartments and or under the seat on a commercial airplane. Although the present invention may potentially be applied to full scale luggage bags, the preferred embodiment focuses primarily on the carryon classification of luggage bag.

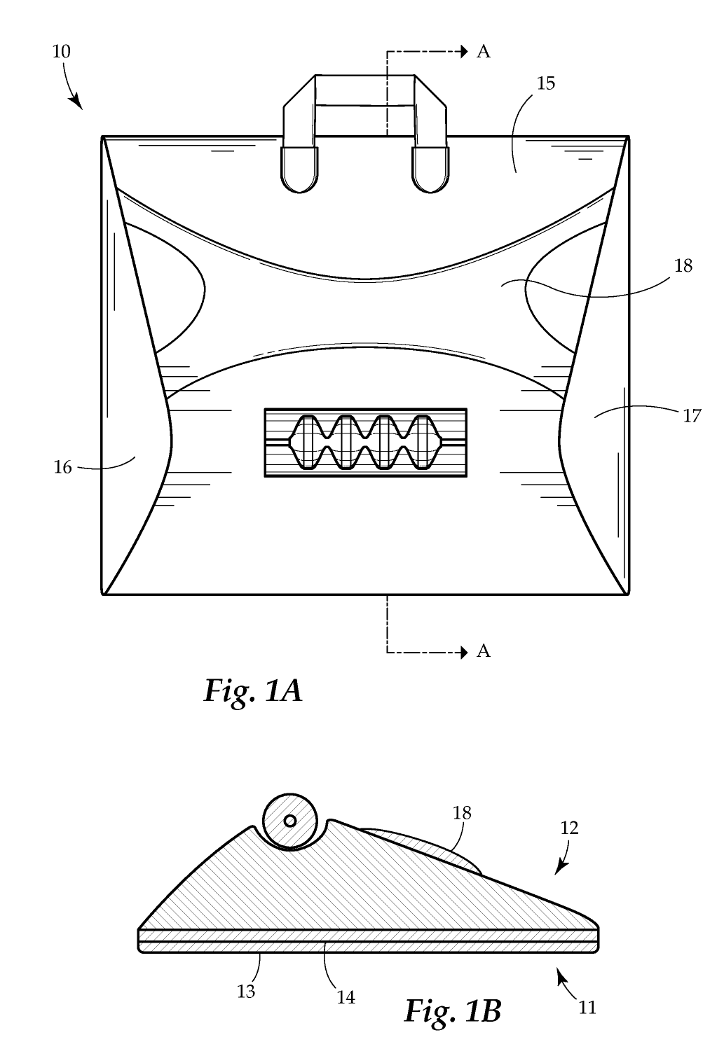

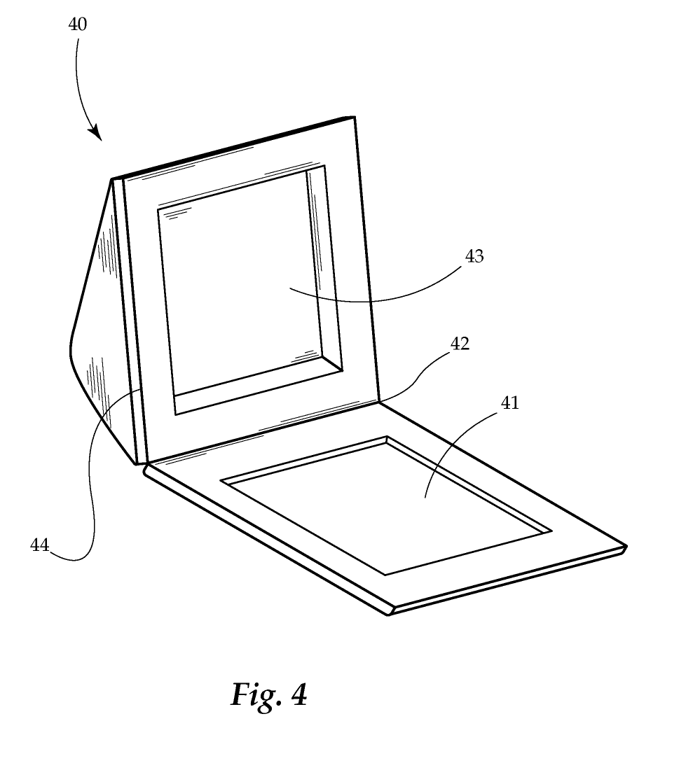

FIG. 1A is an elevation view showing the top and sides of a combination luggage bag and massager according to the present invention. FIG. 1B is a transverse cross-sectional view taken along dotted line AA of FIG. 1A. In this embodiment, the combination luggage bag and massager comprises a housing 10 having a lower portion 11 and an upper portion 12, the lower portion 11 having a base 13 and a peripheral wall 14 being attached to and extending upwardly from the base 13 to form a first compartment 41 (illustrated in FIG. 4). The upper portion 12 having an outwardly curved top surface 15 attached to two opposing surfaces 16/17 on each side to form a generally hollow interior, the hollow interior having a peripheral edge 44 defining an opening into a second compartment 43 as illustrated in FIG. 4. In another embodiment, the upper portion 12 may be pivotally coupled to the lower portion 11 along a common edge 42 ((illustrated in FIG. 4) and may be positionable in a closed position extending over the first compartment. In yet another embodiment, a closure may be attached to the peripheral edge 44 (illustrated in FIG. 4) of the upper portion 12 to secure the upper portion 12 to the lower portion 11 in the closed position. In one embodiment, the closure may be selected from a group including, but not limited to, a zipper, drawstring, concealed magnetic snaps, mechanically affixing snaps, buckles, hook-and-loop fasteners, buttons, clasps, clips, ties and the like.

In still another embodiment, a foot rest 18 may be mounted on the top surface 15 of the combination luggage bag and massager.

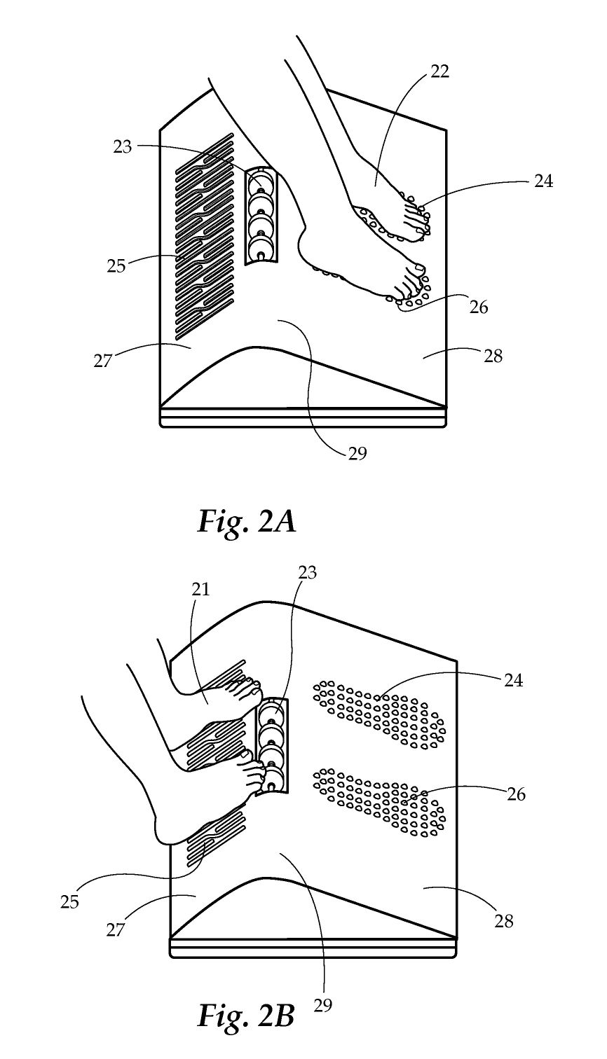

In another embodiment, one massaging device may be mounted on the top surface 15 of the upper portion 12 such that a user can rub a body part against the massaging device when the combination luggage bag and massager is in the horizontal position, the horizontal position being when the base 13 of the lower portion 11 is resting on a generally flat surface. In one embodiment, the massaging device may be formed from various massaging surfaces including, but not limited to, a plurality of protuberances 24, ridges 25, pins, massaging rollers 23 and the like as shown in FIG. 2A. In another embodiment, the massaging surface may be formed in a substantially foot shaped portion 26. The term massaging device as used in this specification includes, but is not limited to massaging surfaces and any other tool that may be used for massaging a body part. Further still, the massaging device may be a battery powered massager that provides mechanical vibrations and the like to enhance the messaging device's efficacy.

FIG. 2A is a perspective view of the present invention showing feet 22 resting on a low angle surface of the invention. FIG. 2B is a perspective view of the present invention showing feet 21 resting on a high angle surface of the invention. In the embodiment shown in FIG. 2B, three massaging devices 23/24/25 may be mounted on the top surface 15 of the upper portion 12 such that a user can rub a body part against any one of the three massaging devices 23/24/25 when the combination luggage bag and massager is in the horizontal position with the base 13 of the lower portion 11 resting on a generally flat surface. In one embodiment, the three massaging devices 23/24/25 may be formed from various massaging surfaces including, but not limited to, a plurality of protuberances 24, ridges 25, pins, massaging rollers 23 and the like. In one embodiment, the massaging surface may be formed in a substantially foot shaped portion 26.

In another embodiment, the top surface 15 of the upper portion 12 may comprise a first angled surface 28 and a second angled surface 27. In this embodiment, the first angled surface 28 and the second angled surface 27 may be angled from the base 13 of the lower portion 11 and diverging downwardly from a raised apex portion 29. In another embodiment, a massaging roller 23 may be mounted on the raised apex portion 29.

In another embodiment, the luggage bag may comprise a generally triangular cross section with a rectangular base. The triangular cross section comprising the upper portion of the luggage bag is generally hollow, having at least one compartment that can be opened to deposit clothes and other items within. The luggage bag is secured shut via a zipper or other convenient fasteners capable of holding the luggage bag closed and preventing any items contained within from spilling out. There is a huge variety of different designs and shapes that can be used to make the luggage bag and any of these forms which are known in the prior art are acceptable for use as the luggage bag in the present invention. Regardless of the specific form of the luggage bag, there are always several flat surfaces onto which the next component of the present invention can be mounted.

The plurality of massaging surfaces and rollers are attached to the outer surfaces of the luggage bag forming something similar to what is displayed in FIG. 1. The purpose of having the plurality of massaging surfaces located on the luggage bag is to allow a traveler to use the present invention to massage their legs and feet from the sitting position when flying on a commercial airplane. This can be achieved if the present invention is laid on the floor of the airplane in front of the traveler's seat. In this position, the traveler can easily rub their feet and or legs against one or more of the plurality of massaging surfaces. The massaging surface can be split into two sections labeled as first angled surface 28 and second angled surface 27 in FIGS. 2A/2B.

The embodiment of the invention shown in FIG. 2A may be designed to provide a massaging surface with lower resting angle to feet in resting position. Typically the first angled surface 28 of the massaging surface shown in FIG. 2A is in the range of 0 to 25 degrees from horizontal. In addition to the static massaging surface, first angled surface 28 may also comprise massaging rollers to improve blood circulation and providing increased relaxation. In one embodiment, any number of rolling massagers could be used. Preferably the number of rolling massagers is either one where the same massager is used for both the feet or a dedicated massager is used for each foot. First angled surface 28 may also comprise a raised surface 18 formed to match the contours of the feet. The raised surface 18 matching contours of feet may provide better support to feet than flat surface. During long flights the user will typically rest with both feet supported on static massage surfaces and occasionally rub feet or other body part on massaging rollers to provide increased blood circulation and relaxation.

The embodiment shown in FIG. 2B may be designed to provide a massaging surface with higher resting angle to feet in resting position. Typically the second angled surface 27 of the massaging surface shown in FIG. 2B is in the range of 25 to 50 degrees. Steeper angle provides increased relaxation to other parts of the body (such as calf muscles) which are not completely relaxed with the lower resting angle position in first angled surface 28. The second angled surface 27 may also comprise static massaging surface and massaging rollers to improve blood circulation and providing increased relaxation. Any number of rolling massagers could be used. Preferably the number of rolling massagers is either the same massager is used for both feet or a dedicated massager is used for each foot. Alternatively, a massaging roller may be mounted on the raised apex portion 29. During long flights the user will typically rest with both the feet supported on the static massage surfaces and occasionally rub feet or other body part on the massaging rollers to provide increased blood circulation and relaxation.

Typically the user will alternate between the first angled surface 28 position and the second angled surface 27 position to provide different positions for feet and avoid positioning them in the same position for long time. To do this the user will typically position the bag to let either the first angled surface 28 or the second angled surface 27 face the user. The user can also use both the first angled surface 28 and the second angled surface 27 without rotating the bag but by simply stretching the legs to use the second angled surface 27 while the first angled surface 28 is facing the user. These positions are shown in FIGS. 2A and 2B. Thus the traveler may choose to have the massaging surface angling upwards away from them; or the opposite, where the massaging surface is angling down away from the user. Either position may be used and may help the user to more easily massage their legs and feet to obtain the desired result of increase comfort.

It is important to note that in the preferred embodiment of the present invention, the plurality of massaging surfaces are comprised of a plurality of geometrically distributed spherical protrusions; this is not necessarily the only configuration that can be used to create the plurality of massaging surfaces. A plurality of geometrically distributed ridges could be used instead; alternatively, different distributions of protrusions and ridges and possibly a combination of the two may be used. Essentially any textured surface may be used in the creation of the plurality of massaging surfaces. It is also contemplated that each of the plurality of massaging surfaces may be comprised of a plurality of geometrically distributed pins which would act as a kind of acupressure to help improve blood flow and reduce muscle tension. In addition to bumps or ridges the flat surface can also incorporate massager rollers to improve blood circulation. The plurality of massaging surfaces are each comprised of plurality of geometrically distributed bumps or ridges. These bumps or ridges are intended to stimulate blood flow and relieve tension in muscles when forcefully contacting the human body. A wide variety of different textures and ridges may be used in the configuration of each of the plurality of massaging surfaces.

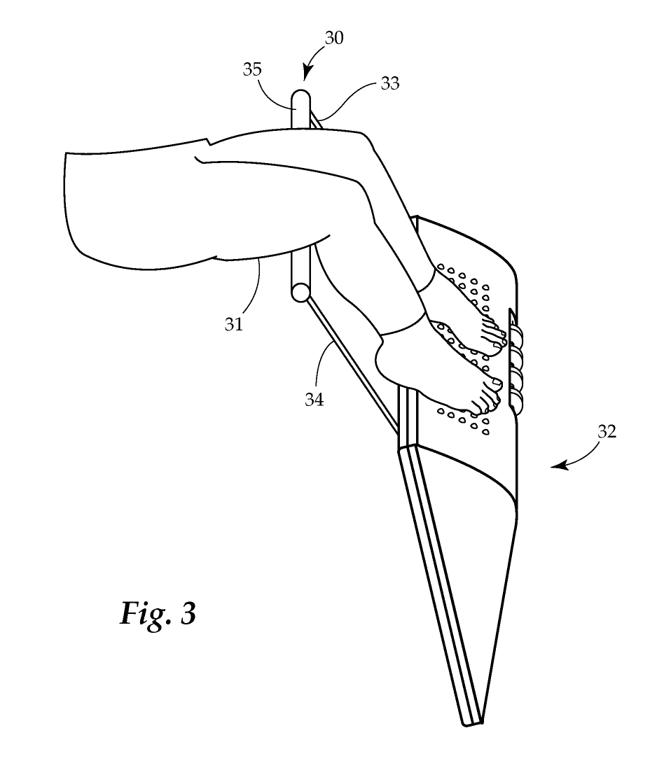

FIG. 3 is another perspective view of the present invention where a handle 30 of the bag is used to provide massaging action to the hamstring muscles 31 and the combination luggage bag and massager bag 32 is used in a vertical position to allow raised elevation for feet and legs. In this embodiment, the handle 30 may comprise a pair of elongated, parallel, and spaced apart side rails 33/34 joined together at one end by a removable crossbar 35. In another embodiment, the crossbar 35 may be a removable massaging roller which a user may be able to readily bring about a back and forth rolling movement of the massaging roller and consequently cause a massaging action to the portion of the user's body in contact with the massaging roller when the combination luggage bag and massager 32 is in the vertical position.

This position allows the legs and feet to rest in an elevated position which provides improved relaxation and blood circulation. In this position the user can simply rest in the elevated leg position while resting his/her feet on the static massage surface with the hamstring supported by the handle or occasionally use the rolling massagers to provide additional massaging action. For the handle to work as a massaging surface and to provide support to hamstring muscles the width of the handle is increased to support both legs. In this position the user can also occasionally massage the back of the legs (calf muscles) using massaging rollers.

In one embodiment a soft removable cushion surface may be strapped onto handle to provide increased relaxation and ease pressure due to hard handle surface. In another embodiment, soft cushion may be replaced by a removable massaging roller. These removable massaging rollers or soft cushion wrap are stored within the luggage bag when the rolling massager is not in use. This allows handle function to be properly gripped without any interference by rollers or cushion wraps. When in the sitting position, the traveler can extent the rolling massager to a length of their choosing and massage the backs of their legs to improve blood flow and relieve muscle tension. This can drastically improve the comfort of the user. Thus, the traveler can roll their leg back and forth and up and down on the rolling massager, achieving maximum improvement in blood flow, and subsequently, comfort.

In another embodiment, the rolling massager may be used to massage and support hamstrings such that the feet can be supported on the top side of the luggage.

In yet another embodiment, the vertical position may be used to simply allow feet to rest in elevated leg position without including the handle for the hamstring massager.

FIG. 4 is a detail perspective view of the bag in open position showing checkpoint friendly first compartment 41 for storing a portable computer, e.g. a laptop. In this embodiment, the first compartment 41 may be constructed and arranged to store a portable computer and to allow unfastening and unfolding of the first compartment 41 without having to remove the portable computer from the first compartment 41. The computer section of the bag is typically checkpoint friendly so that it can easily be passed through security checkpoints without the need to remove laptop from bag.

In another embodiment, a method for massaging a body part using a combination luggage bag and massager is presented. The method may begin by providing a combination luggage bag and massager with a massaging device mounted on a top surface of an upper portion of the bag. This may be followed by positioning the combination luggage bag and massager in a horizontal position with the base of a lower portion of the bag resting on a generally flat surface. A user may then rub a body part against the massaging device when the combination luggage bag and massager is in the horizontal position.

In another embodiment, the method may further involve extending a handle of the combination luggage bag and massager outwardly from an end of the bag. This may be followed by replacing a removable crossbar of the handle with a massaging roller and positioning the combination luggage bag and massager in a vertical position, the vertical position being when a front of the bag is resting on a generally flat. A user may then bring about a back and forth rolling movement of the massaging roller and consequently cause a massaging action to the portion of the user's body in contact with the massaging roller when the combination luggage bag and massager is in the vertical position.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A combination luggage bag and massager, the combination luggage bag and massager comprising:
a housing, the housing having a lower portion and an upper portion;
the lower portion having a base and a peripheral wall being attached to and extending upwardly from the base to form a first compartment;
the upper portion having an outwardly curved top surface attached to two opposing surfaces on each side to form a generally hollow interior, the hollow interior having a peripheral edge defining an opening into a second compartment;
the upper portion being pivotally coupled to the lower portion along a common edge and being positionable in a closed position extending over the first compartment, a closure being attached to the peripheral edge of the upper portion to secure the upper portion to the lower portion in the closed position; and
a massaging device mounted on the top surface of the upper portion such that a user can rub a body part against the massaging device when the combination luggage bag and massager is in the horizontal position with the base of the lower portion resting on a generally flat surface.

2. The combination luggage bag and massager of claim 1 wherein the massaging device is formed from a massaging surface selected from a group consisting of a plurality of protuberances, ridges, pins, massaging rollers and combinations thereof.

3. The combination luggage bag and massager of claim 2 wherein the massaging surface is formed in a substantially foot shaped portion.

4. The combination luggage bag and massager of claim 1 wherein a second massaging device is mounted on the top surface.

5. The combination luggage bag and massager of claim 4 wherein the second massaging device is formed from a massaging surface selected from a group consisting of a plurality of protuberances, ridges, pins, massaging rollers and combinations thereof.

6. The combination luggage bag and massager of claim 1 wherein the top surface of the upper portion comprises a first angled surface and a second angled surface, the first angled surface and the second angled surface being angled from the base of the lower portion and diverging downwardly from a raised apex portion.

7. The combination luggage bag and massager of claim 4 wherein the first angled surface is at an angle of about 0 degrees to about 25 degrees from the base of the housing.

8. The combination luggage bag and massager of claim 6 wherein a massaging device is mounted on the first angled surface of the top surface.

9. The combination luggage bag and massager of claim 6 wherein a massaging roller is mounted on the raised apex portion.

10. The combination luggage bag and massager of claim 6 wherein a second massaging device is mounted on the second angled surface of the top surface.

11. The combination luggage bag and massager of claim 1 wherein the first compartment is constructed and arranged to store a portable computer and to allow unfastening and unfolding of the first compartment without having to remove the portable computer from the first compartment.

12. The combination luggage bag and massager of claim 1 wherein the closure is selected from a group consisting of a zipper, drawstring, concealed magnetic snaps, mechanically affixing snaps, buckles, hook-and-loop fasteners, buttons, clasps clips, ties and combinations thereof.

13. The combination luggage bag and massager of claim 1 wherein the massaging device is battery operated.

14. The combination luggage bag and massager of claim 1 further comprising an elongated retractable handle slidably mounted and pivotally attached to the housing.

15. The combination luggage bag and massager of claim 14 wherein the handle comprises a pair of elongated, parallel, and spaced apart side rails joined together at one end by a removable crossbar.

16. The combination luggage bag and massager of claim 14 wherein the handle is movable between a storage position in which at least most of the handle is contained within the housing, and an extended position in which the handle extends outwardly from an end of the housing.

17. The combination luggage bag and massager of claim 15 wherein the crossbar is a removable massaging roller which a user is able to readily bring about a back and forth rolling movement of the massaging roller and consequently cause a massaging action to the portion of the user's body in contact with the massaging roller when the combination luggage bag and massager is in the vertical position.

18. The combination luggage bag and massager of claim 16 wherein the crossbar is a soft cushion wrap.

19. A method of massaging a body part using a combination luggage bag and massager comprising the steps of:
providing the combination luggage bag and massager comprising:
a housing, the housing having a lower portion and an upper portion;
the lower portion having a base and a peripheral wall being attached to and extending upwardly from the base to form a first compartment;
the upper portion having an outwardly curved top surface attached to two opposing surfaces on each side to form a generally hollow interior, the hollow interior having a peripheral edge defining an opening into a second compartment;
the upper portion being pivotally coupled to the lower portion along a common edge and being positionable in a closed position extending over the first compartment, a closure being attached to the peripheral edge of the upper portion to secure the upper portion to the lower portion in the closed position; and
a massaging device mounted on the top surface of the upper portion; and
a retractable handle slidably mounted and pivotally attached to the housing, the handle comprising a pair of elongated, parallel, and spaced apart side rails joined together at one end by a removable crossbar, the handle movable between a storage position in which at least most of the handle is contained within the housing, and an extended position in which the handle extends outwardly from a rear end of the housing.
positioning the combination luggage bag and massager in a horizontal position with the base of the housing resting on a generally flat surface; and
rubbing a body part against the massaging device when the combination luggage bag and massager is in the horizontal position.

20. The method of massaging a body part using a combination luggage bag and massager further comprising the steps of:
extending the handle outwardly from the end of the housing;
replacing the removable crossbar with a massaging roller;
positioning the combination luggage bag and massager in a vertical position with a front of the housing resting on a generally flat surface; and
bringing about a back and forth rolling movement of the massaging roller and consequently causing a massaging action to the portion of the user's body in contact with the massaging roller when the combination luggage bag and massager is in the vertical position.
